(19) United States
(12) Patent Application Publication
(10) Pub. No.: US 2002/0134919 A1
(43) Pub. Date: Sep. 26, 2002

(54) Optical detector-preamplifier subassembly

(76) Inventors: Theodore E. Washburn, Barrington, IL (US); Harvey B. Serreze, Pepperell, MA (US)

Correspondence Address: David L. Newman, Esq., Stratos Lightwave, Inc., 7444 West Wilson Avenue, Chicago, IL, 60706, US

(21) Appl. No.: 09/816,984

(22) Filed: Mar. 24, 2001

(51) Int. Cl. G02B 6/42

(52) U.S. Cl. 250/214 A

(57) ABSTRACT

A detector-preamplifier subassembly for an optical receiver comprising a header base having a top surface and a bottom surface, a plurality of leads passing through the top and bottom surfaces of the header base, a preamplifier mounted to the top surface of the header base, a standoff mounted to the top surface of the header base, a photodetector mounted to the standoff, and said standoff comprising a single-layer capacitor, wherein the single-layer capacitor functions as both a capacitor for the detector-preamplifier subassembly and a standoff for properly positioning the photodetector above the top surface of the header base. In this manner, the separate capacitors and several wire bonds are eliminated, thus increasing available surface area on the header base and improving performance and reliability of the detector-preamplifier subassembly and the optical receiver.

### FIELD OF THE INVENTION

The present invention relates generally to a receiver optical subassembly. More particularly, the present invention relates to a detector-preamplifier subassembly of an optical receiver having increased usable surface area and a reduced number of separate components.

### BACKGROUND OF THE INVENTION

Current detector-preamplifier subassemblies for optical receivers utilize various components mounted on a header base. These components typically include a photodetector, a preamplifier, a standoff, and capacitors. The components are electrically interconnected with wire bonds. The capacitors function to provide a power supply bypass so the detector and the preamplifier have a steady source of voltage and current.

The standoff provides both a mechanical and an electrical function. The thickness of the standoff positions the detector chip, which is mounted on the surface of the standoff, at the correct height above the surface of the header base. The correct height and position for the detector chip is determined by the focal length of the receiving lens focusing inputted light signals onto the detector. The top surface of the standoff is metalized and provides an electrical connection to the bottom of the detector chip, which is attached to the surface of the standoff with a conductive adhesive. The body of the standoff is made of ceramic material, which electrically insulates the detector from the metal surface on the header base.

All the components on the surface of the header base must compete for available real estate. The real estate or available surface area for mounting additional components to the header base is limited due to the surface area being utilized by the original components. Additionally, components on the header base are connected by wire bonds, which can be quite numerous. The wire bonds increase the cost of the detector-preamplifier subassembly and increase the risk of a failed connection via a poor wire bond. The wire bonds also add inductance which can degrade the high-frequency performance of the detector-preamplifier subassembly.

Accordingly, there is a need for a detector-preamplifier subassembly in an optical receiver that reduces the number of components and wire bonds on the surface of the header base.

### OBJECTS AND SUMMARY OF THE INVENTION

An object of the present invention is to reduce the cost of the detector-preamplifier subassembly by reducing the number of separate components on the header base of the detector-preamplifier subassembly.

Another object of the present invention is to increase the surface area available for additional components.

A further object of the present invention is to reduce the number and length of wire bonds utilized to electrically connect components mounted to the surface of the header base of a detector-preamplifier subassembly.

An additional object of the present invention is to reduce parasitic inductances and improve high frequency performance by shortening the length of the wire bonds.

Another object of the present invention is to improve receiver reliability by reducing the number of separate components and wire bonds connected thereto.

According to the present invention, a detector-preamplifier subassembly is provided having a capacitor formed into the standoff which is mounted on the surface of the header base. In this manner, the separate capacitors, and wire bonds connected to the separate capacitors, on the header are eliminated. This increases the available real estate on the header base and reduces the number of wire bonds. The standoff is formed out of ceramic material having the appropriate electrical properties, such as the desired dielectric constant, dissipation factor, and resistivity. Conventional standoffs are made of aluminum oxide ceramic having a dielectric constant of approximately 9. A standoff configured in accordance with the present invention is constructed of numerous ceramic materials, including titanium dioxide, barium titanate, calcium titanate, magnesium titanate, or combinations of these with aluminum oxide and other materials. Using a combination of these materials, any dielectric constant in the range of 10 to 6,500 can be obtained. When formed into a flat, thin wafer, these ceramic materials can be metalized and cut into small squares.

### BRIEF DESCRIPTION OF THE DRAWINGS

FIG. 1 is an exploded view of a prior art, optical receiver;

FIGS. 2a, 2b, and 2c are cross-sectional, bottom, and top views of a prior art, optical, detector-preamplifier subassembly;

FIG. 3 is an enlarged, more detailed, top view of the detector-preamplifier subassembly shown in FIG. 2c;

FIG. 4 is a top view of a detector-preamplifier subassembly configured in accordance with a first embodiment of the present invention;

FIG. 4a is an enlarged view of the standoff and photodetector shown in FIG. 4;

FIG. 5 is a top view of a detector-preamplifier subassembly configured in accordance with a second embodiment of the present invention; and

FIG. 6 is a circuit diagram equivalent to the first and second embodiments shown in FIGS. 4 and 5.

### DETAILED DESCRIPTION OF THE PRESENTLY PREFERRED EMBODIMENTS

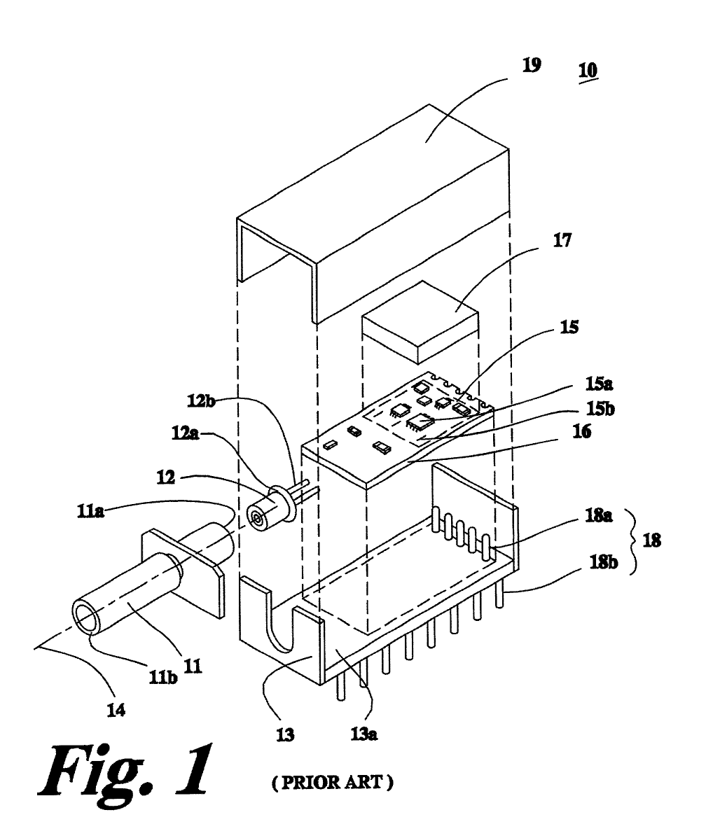

Referring now to the drawings, FIG. 1 illustrates a prior art, optical receiver 10. A first end 11a of an optical connector or barrel 11 is sized to receive a detector-preamplifier subassembly 12. A second end 11b of the barrel 11 is sized to receive an external optical ferrule (not shown). The detector-preamplifier subassembly 12 is aligned with an optical axis 14 and then mounted to the first end 11a of the barrel 11. The detector-preamplifier subassembly 12 includes a header base 12a and header leads 12b. The barrel 11 is mounted to a housing 13 by an adhesive or similar mounting process. A substrate 16 supporting an electronic circuit 15, including individual electronic components such as an integrated circuit (IC) 15a, is mounted to a base 13a of the housing 13. The IC 15a and other components on the substrate 16, as well as wires 15b for connecting the IC 15a to a wiring pattern on the substrate 16, are sealed by an internal lid 17. The housing 13 includes lead pins 18, which include inner leads 18a inside the housing 13 and outer leads 18b outside the housing 13. The inner leads 18a, the electronic circuit 15 on the substrate 16, as well as the header leads 12b are electrically connected by wire bonding or soldering. A cover 19 is mounted to the housing 13. The cover 19 encloses the substrate 16, the inner leads 18a, the header base 12a, the header leads 12b, and the first end 11a of the barrel 11.

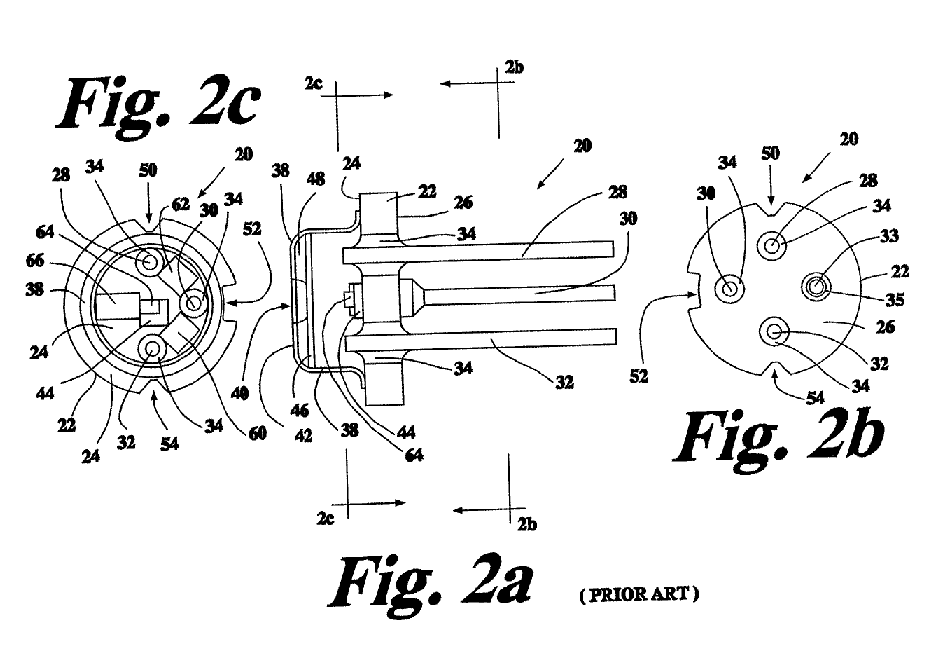

FIGS. 2a-2c are cross-sectional, bottom, and top views of a prior art, detector-preamplifier subassembly 20. Referring first to FIG. 2a, a cross-sectional side view of the detector-preamplifier subassembly 20 is shown. A header base 22 has a first or top surface 24 and a second or bottom surface 26. Leads 28, 30, 32 pass through the header base 22 and extend beyond both the top surface 24 and the bottom surface 26. Lead 28 is the negative (−) differential signal output, lead 30 is the DC bias input (typically 3-5 volts), and lead 32 is the (+) differential signal output. Insulating material 34, such as glass, surrounds and insulates each of the leads 28,30,32 from the header base 22. The leads 28,30,32 are constructed of conductive material, such as Kovar, gold plated Kovar, or other low-expansion, iron-nickel alloys plated with gold. The header base 22 is constructed of steel, Kovar, or gold-plated Kovar. The insulating material 34 is constructed of borosilicate or other glass, or ceramic, and fused to the header base 22 and around the leads 28,30,32 by thermal heating processes such as reflow or melting.

A cap 38 is mounted to the top 24 of the header base 22 by the process of resistance welding, soldering, or brazing. The cap 38 is constructed of a metal, such as Kovar, or other low-expansion, iron-nickel alloy, or pure nickel. The cap 38 protects components mounted to the top surface 24 of the header base 22. An opening or aperture 40 is located at the top 42 of the cap 38, which allows light signals to pass though the top 42 of the cap 38 and onto a detector 64 mounted to a standoff 44 which is itself mounted to the top surface 24 of the header base 22. A glass barrier 46 is located within the cap 38, adjacent to the aperture 40. The glass barrier 46 protects components mounted on the top surface 24 of the header base 22 from external elements, while allowing light signals to pass onto the detector 64. A bonding material 48 secures the glass barrier 46 within the cap 38. The bonding material 48 preferably is glass fused to the cap 38, but may be an organic polymer adhesive or epoxy.

FIG. 2b is a plan view of the bottom surface 26 of the header base 22 shown in and taken along line 2b-2b of FIG. 2a. Leads 28,30,32 are shown. A fourth lead, case ground lead 33, is also shown. The case ground lead 33 is secured to the bottom surface 26 of the header base 22 by bonding material 35. The bonding material 35 preferably is solder or a welding metal. Lead 33 does not pass through the surface 24 of the header base 22. The insulating material 34 is shown surrounding leads 28, 30, 32. Positioning notches 50,52,54 are included on the periphery of the header base 22.

FIG. 2c is a plan view of the top surface 24 of the header base 22 shown in and taken along line 2c-2c of FIG. 2a. Leads 28,30,32 and the insulating material 34 are illustrated. Also illustrated are the edge of cap 38, the standoff 44, and the positioning notches 50,52,54.

In addition, photodetector 64 and preamplifier 66 are illustrated. The standoff 44 is preferably constructed of a ceramic, which electrically insulates the detector 64 from the surface 24 of the header base 22. The standoff 44 also functions to position the detector 64 at the proper focal length of an optical lens (not shown), external to the detector-preamplifier subassembly 20, which directs light signals through the aperture 40 and onto the detector 64. In some embodiments the glass barrier 46 can be shaped to function as a lens to accurately focus light rays entering through the aperture 40 onto the detector 64. U.S. Pat. Nos. 6,071,017, 6,061,493, 5,815,623, 5,812,717, and 5,812,582, all assigned to Stratos Lightwave, illustrate several lens configurations for focusing light signals into a detector-preamplifier subassembly; and all these patents are hereby incorporated by reference into this application. Capacitors 60,62 are also so shown mounted to the surface 24 of the header base 22.

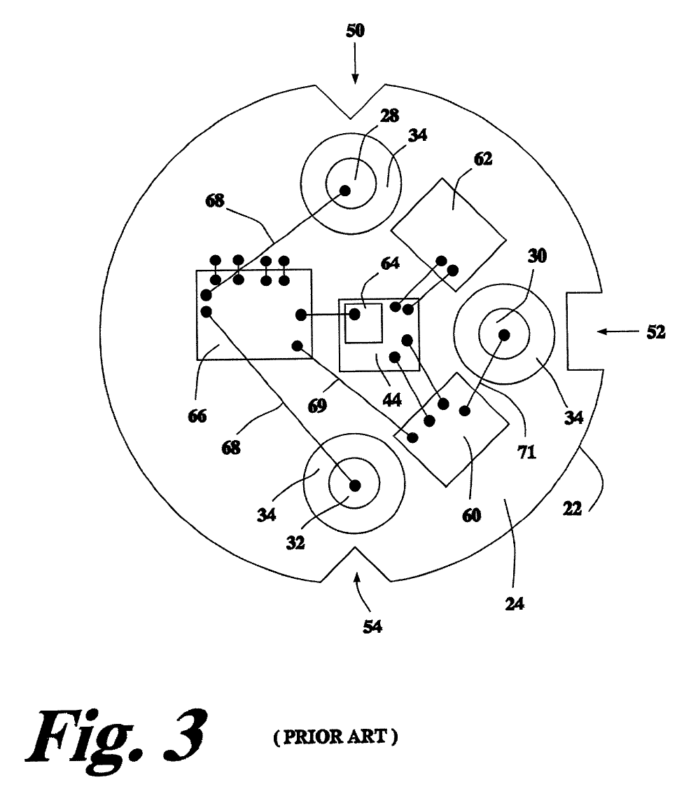

FIG. 3 is an enlarged view of the surface 24 of the prior art header base 22 shown in FIG. 2c. As shown in FIG. 3, conventional optical receivers generally have five separate components on the surface 24 of the header base 22: two capacitor chips 60,62, a ceramic standoff 44, a detector 64, and a preamplifier 66. The separate components are electrically connected by wire bonds 68,69,71. The detector 64 is preferably a p-i-n or “pin” photodiode. The capacitors 60,62 are preferably RF (radio frequency) bypass or decoupling capacitors, each typically 470 or 510 picofarads (pF). The detector 64, a pin photodiode, is mounted on top of the standoff 44. The preamplifier 66 is preferably a trans-impedance amplifier (TIA) chip. Numerous wire bonds 68,69,71 electrically connect the capacitors 60,62 to the lead 30, the standoff 44, and the preamp 66.

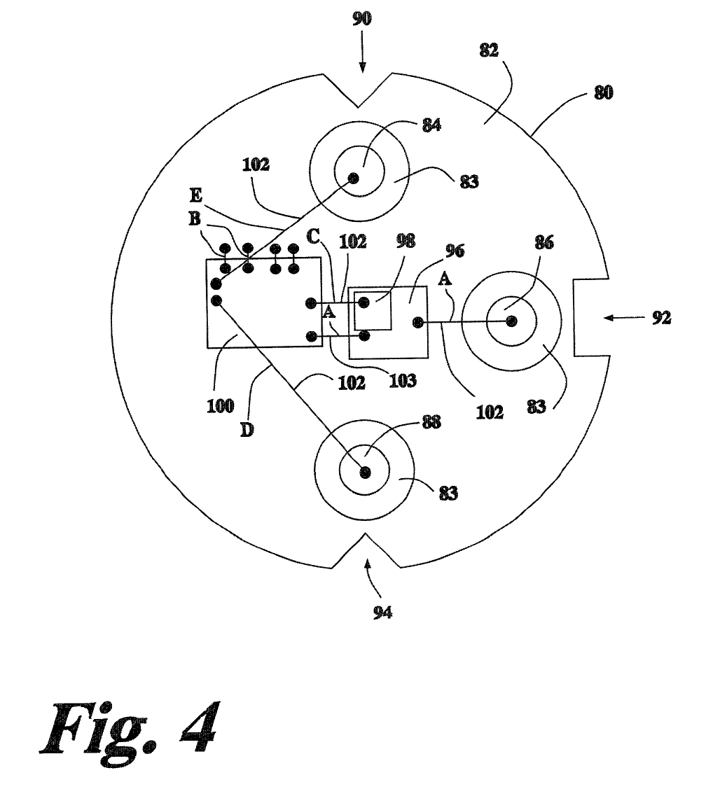

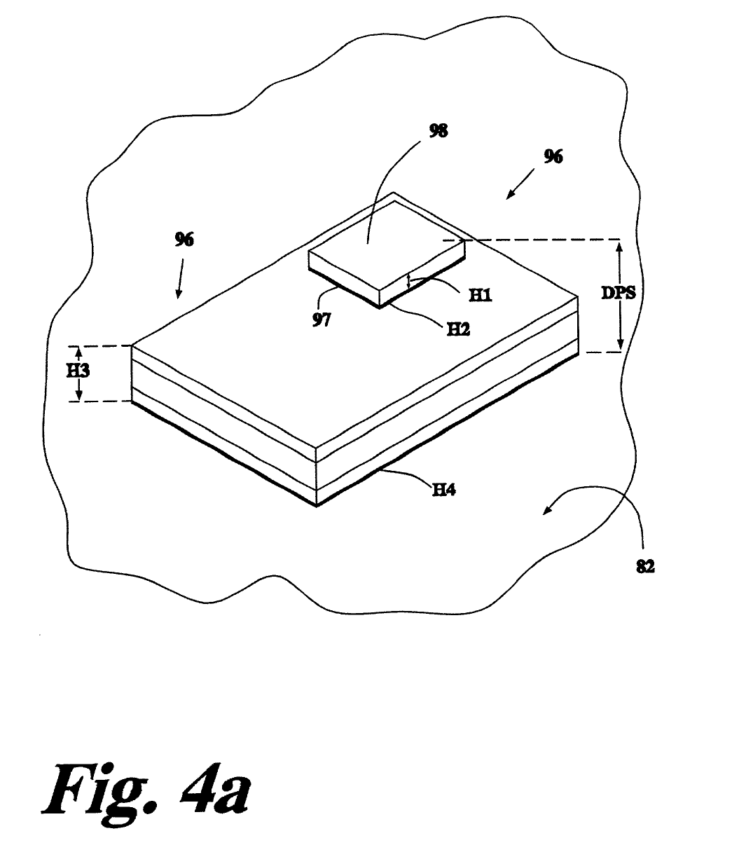

Turning now to FIG. 4, illustrated is a header base 80 configured in accordance with a first embodiment of the present invention. Leads 84,86,88 are shown passing through the top surface 82 of the header base 80. Insulating material 83 positions the leads 84,86,88 within the header base 80 and electrically insulates the leads 84,86,88 from the header base 80. Positioning notches 90,92,94 are located on the periphery of the header base 80. A ceramic standoff 96 is mounted to the surface 82 of the header base 80. A photodetector 98 is mounted to the surface of the standoff 96. A preamplifier 100 is also mounted to the surface 82 of the header base 80. Wire bonds 102 electrically connect the leads 84,86,88 to the standoff 96, the detector 98, and the preamplifier 100.

In accordance with the present invention, capacitors 60,62 (FIGS. 2c and 3), as separate components, have been eliminated from the surface 82 of the header base 80. Furthermore, numerous wire bonds 68 (FIG. 3) previously necessary to electrically connect the separate capacitors 60,62 have also been eliminated. The present invention achieves this improvement by incorporating capacitive functions within the standoff and utilizing a single-layer ceramic capacitor as a standoff.

The elimination of wire bonds improves electrical performance of a detector-preamplifier subassembly. Wire bonds produce inductance, an undesired factor at high frequencies in the electrical circuit on the header base. Shortening or eliminating wire bonds 102, as shown in FIG. 4, lowers or eliminates inductance at that location in the overall circuit. The present invention enables the bottom of the detector chip 98 to be in direct electrical contact with the standoff 96. The standoff 96 provides capacitive functions. Furthermore, individual wire bond 103, which supplies power to the preamplifier 100 from the standoff 96, replaces prior art wire bond 69 (FIG. 3), which previously supplied power to the preamplifier 66 (FIG. 3) from the capacitor 60 (FIG. 3). As can be seen in FIGS. 3 and 4, the individual wire bond 103 is much shorter than the prior art wire bonds 69,71, thus reducing inductance in this sensitive area of the circuit which is extremely important at high frequencies.

Moreover, in accordance with the preferred embodiment of the present invention, the number of total wire bonds is reduced from 13, as required in the prior art (FIG. 3), to 9 wire bonds as shown in FIG. 4. Also, the maximum allowed dimensions of the capacitor, which also functions as the standoff 96, can be increased because there is now more free surface area on the header base 80 due to the elimination of prior art capacitors 60,62 (FIG. 3). The prior art capacitors 60,62 could not be greater than 0.025 inches, otherwise the capacitors 60,62 would overlap the insulating material 34 and leads 28,30,32 (FIG. 3). Specific dimensions of header bases are available, for example, from Schott Electronic Packaging in Landshut, Germany (US office: Westborough, Mass.) or Shinko Electric Industries located in Nagano, Japan (US office: San Jose, Calif.).

By replacing the standoff 96 at the center of the header base 80 with a capacitor and eliminating prior art capacitors 60,62, significantly larger sized capacitors can be accommodated by the header base 80. For example, a capacitor/standoff 96 having a width of 0.040 inches can be easily accommodated by the header base 80.

Preferably, the preamplifier or TIA 100 is a Nortel AB89, the standoff/capacitor 96 is a Presidio (Model Number SL3535X7R102K2G5) single-layer 1000 pF capacitor. The detector 98 is a PIN diode (Model Number D-85-50-2) manufactured by Bandwidth Semiconductor, LLC in Bedford, Mass. Other TIAs can be used for the preamplifier 100, such as those manufactured by Philips, Maxim, AMCC, AZM, Infineon, and Nortel. Other single-layer capacitors can be used provided the capacitors possess adequate capacitance and operating voltage levels, and have a suitable thickness. Other detectors 98 can be used, provided the detectors possess suitable electrical, optical, and physical characteristics such as operating wavelength, responsivity, high frequency cut-off, length, width, and thickness.

FIG. 4a is an enlarged view of the standoff 96 and detector (photodiode or photodetector) 98 shown in FIG. 4, which is configured in accordance with the present invention. The single-layer ceramic capacitor, which also functions as the standoff 96, is constructed in accordance with known techniques for single-layer ceramic capacitors. For example, Dielectric Laboratories located in Cazenovia, N. Y., produces several types of single-layer ceramic capacitors, such as the DiCap®, the T-Cap, and Border Caps. Similarly, Presidio Components of San Diego, Calif., manufactures Buried Single-layer™ Ceramic Capacitors. Furthermore, Johanson Technology located in Camarillo, Calif., manufactures Grain Boundary Layer (GBBL) single-layer capacitors.

The standoff 96 is composed of an individual, single-layer ceramic capacitor, preferably having a capacitance of 1000 pF. In accordance with the present invention, the capacitor/standoff 96 provides the dual role as: 1) a direct current (DC) insulating spacer between the detector or pin diode 98 and the surface 82 of the header base 80; 2) a platform to properly position the top surface of the detector 98 at the focal point of an optical lens directing received light signals onto the detector 98; and 3) a metalized surface to provide electrical contact to the bottom of the detector 98 through a conductive adhesive 97.

An important consideration in constructing a detector-preamplifier subassembly configured in accordance with the present invention is the detector plane specification (DPS). This parameter (DPS) is the height of the top surface of the pin diode 98 above the header surface 82. In the prior art, this dimension is 0.027+/−0.002 inches, and is achieved by stacking a 0.010 inch (H1) thick pin diode on a 0.015 inch (H3) thick ceramic spacer using conductive epoxy of 0.001 inch (H2, H4) thickness at the two interfaces (0.010+0.015+0.001+0.001=0.027). In the preferred embodiment of the present invention the detector plane specification (DPS), as shown in FIG. 4a, is achieved by using a thicker pin diode detector 98 (0.020 inches as H1) and a thinner standoff/capacitor 98 (0.005 inches as H3) than prior art standoffs. As shown in FIG. 4a, the DPS is 0.020 (H1)+0.001 (H2)+0.005 (H3)+0.001 (H4)=0.027 inches. Of course, any other detector place specification can be achieved by proper choice of the detector 98 and the capacitor/standoff 96 thicknesses.

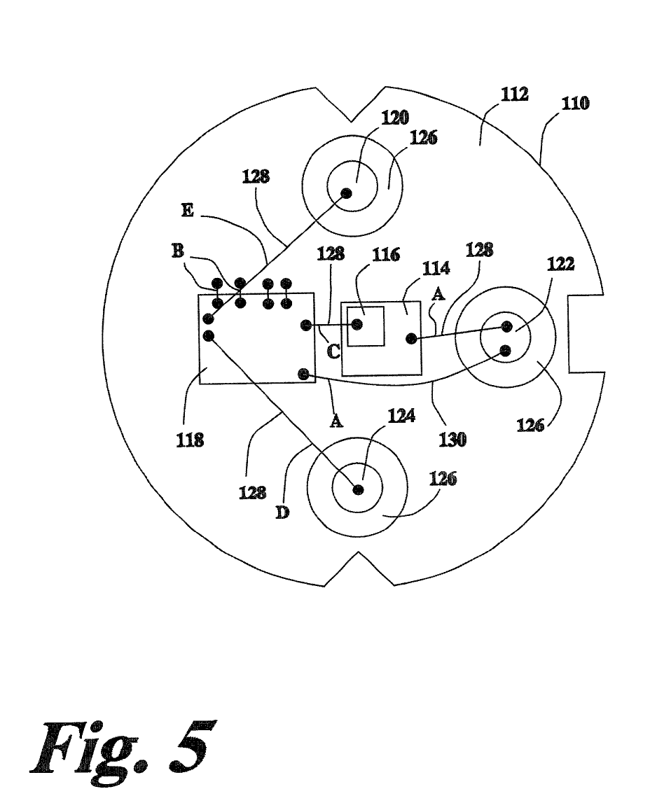

FIG. 5 illustrates a header base 110 configured in accordance with a second embodiment of the present invention. Mounted on the surface 112 of the header base 110 are a standoff/capacitor 114, a detector 116, and a preamplifier 118. Leads 120, 122, 124 pass through the header base 110. Each of the leads 120,122,124 are mounted and electrically insulated by insulating material 126, such are molded glass. Numerous wire bonds 128 electrically connect the leads 120,122,124 with the standoff 114, the detector 116, and the preamplifier 118.

As a modification of the first embodiment shown in FIG. 4, the second embodiment of the invention allows the preamplifier 118 to be powered directly from lead 122 via individual bond wire 130. This is a slight modification over the first embodiment wherein the preamplifier 100 (FIG. 4) is powered from the standoff 96 via individual bond wire 103. The advantage to this configuration is improving inductive decoupling of RF signals between the photodiode 116 and the bias input terminal of the preamplifier 118.

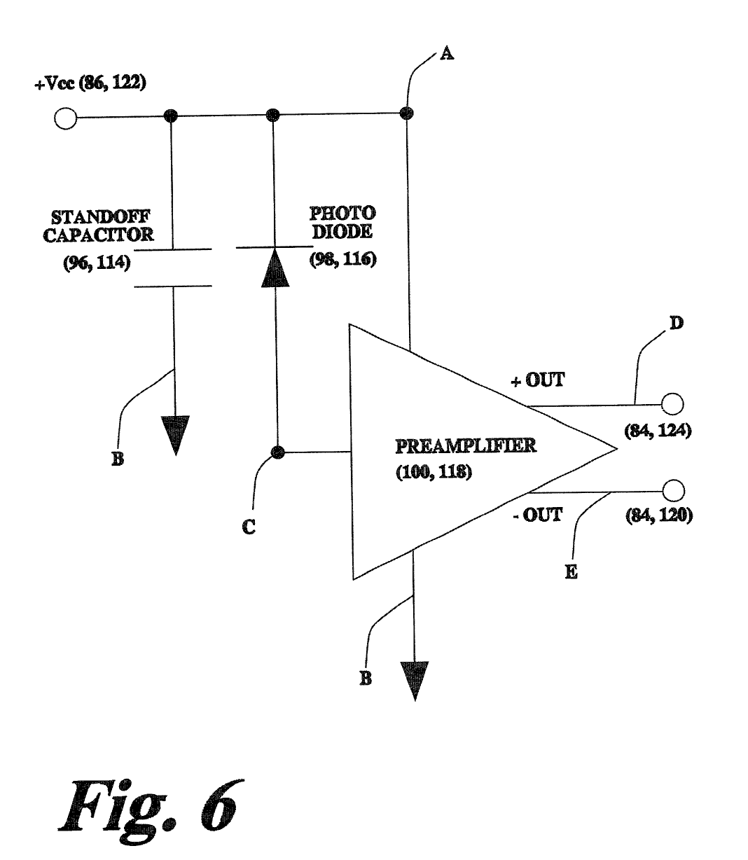

FIG. 6 is a circuit diagram corresponding to the embodiments shown in FIGS. 4 and 5. FIG. 6 shows the components including the standoff/capacitor 96,114, the photodiode 98, 116, and the preamplifier 100,118. Also represented is the positive differential signal output lead 88,124, the negative differential signal output lead 84,120, and the DC bias input lead (Vcc) 86, 122. Common electrical nodes and connections are labeled A,B,C,D,E in FIGS. 4, 5, and 6. It should be noted that the surface 82,112 of the header base 80,110 is electrically conductive and provides a common ground to multiple leads from the preamplifier, as indicated by letter “B”. Similarly, the top surface of the standoff/capacitor 96,114 is electrically conductive, and thus provides a common node and connection, as indicated by letter “A” in FIG. 4.

Although wire bond 103 in FIG. 4 is connected differently than wire bond 130 in FIG. 5, the first and second embodiments shown in FIGS. 4 and 5, respectively, are electrically equivalent from a perspective of common electrical nodes. Of course, there are inductance and impedance distinctions between the first and second embodiments shown in FIGS. 4 and 5 due to the different wire bond lengths between the first and second embodiments.

It is to be understood that the foregoing description is merely a disclosure of particular embodiments and is no way intended to limit the scope of the invention. Several possible alterations and modifications will be apparent to those skilled in the art.

We claim as our invention:

1. A detector-preamplifier subassembly for an optical receiver, comprising:
a header base having a top surface and a bottom surface;
a plurality of leads passing through the top and bottom surfaces of the header base;
a preamplifier mounted to the top surface of the header base;
a standoff mounted to the top surface of the header base;
a photodetector mounted to the standoff; and
said standoff comprising a single-layer capacitor, wherein the single-layer capacitor functions as both a capacitor for the detector-preamplifier subassembly and a standoff for properly positioning the photodetector above the top surface of the header base.

2. The detector-preamplifier subassembly of claim 1, wherein the plurality of leads includes three leads: a DC bias input lead, a positive (+) differential signal output lead, and a negative (−) differential signal output lead.

3. The detector-preamplifier subassembly of claim 1, further comprising:
a case ground lead on the bottom surface of the header base.

4. The detector-preamplifier subassembly of claim 1, further comprising:
wire bonds electrically connecting the leads with the preamplifier and the standoff.

5. The detector-preamplifier subassembly of claim 1, further comprising:
a wire bond electrically connecting the standoff to the preamplifier.

6. The detector-preamplifier subassembly of claim 2, further comprising:
a first wire bond electrically connecting the standoff to the preamplifier;
a second wire bond electrically connecting the photodetector to the preamplifier; and
a third wire bond electrically connecting the standoff to the DC bias input lead.

7. The detector-preamplifier subassembly of claim 6, further comprising:
a fourth wire bond connecting the positive (+) differential signal output lead to the preamplifier; and
a fifth wire bond electrically connecting the negative (−) differential signal output lead to the preamplifier.

8. The detector-preamplifier subassembly of claim 7, further comprising:
four individual wire bonds electrically connecting the preamplifier directly to the top surface of the header base.

9. The detector-preamplifier subassembly of claim 8, wherein the total number of individual wire bonds on the header base is less than ten (10).

10. The detector-preamplifier subassembly of claim 2, further comprising:
a first wire bond electrically connecting the photodetector to the preamplifier;
a second wire bond electrically connecting the standoff to the DC bias input lead; and
a third wire bond electrically connecting the preamplifier to the DC bias input lead.

11. The detector-preamplifier subassembly of claim 10, further comprising:
a fourth wire bond connecting the positive (+) differential signal output lead to the preamplifier; and
a fifth wire bond electrically connecting the negative (−) differential signal output lead to the preamplifier.

12. The detector-preamplifier subassembly of claim 11, further comprising:
four individual wire bonds electrically connecting the preamplifier directly to the top surface of the header base.

13. The detector-preamplifier subassembly of claim 12, wherein the total number of individual wire bonds on the header base is less than ten (10).

14. The detector-preamplifier subassembly of claim 1, wherein the standoff is bonded to the header base using a conductive adhesive.

15. The detector-preamplifier subassembly of claim 1, wherein the photodetector is mounted to the standoff using a conductive adhesive.

16. The detector-preamplifier subassembly of claim 1, wherein the single-layer capacitor forming the standoff has a capacitance of approximately 1000 pF.

17. The detector-preamplifier subassembly of claim 1, wherein the photodetector has a thickness of approximately 0.020 inches, and the standoff has a thickness of approximately 0.005 inches.

18. An optical receiver subassembly, comprising:
a header base having a top surface and a bottom surface;
a DC bias input lead passing through the top and bottom surface of the header base;
a positive differential signal output lead passing through the top and bottom surfaces of the header base;
a negative differential signal output lead passing through the top and bottom surfaces of the header base;
a case ground lead on the bottom surface of the header base;
a preamplifier mounted to the top surface of the header base;
a standoff-capacitor conductively mounted in the center and top surface of the header base;
a photodetector conductively mounted to the standoff;
said standoff-capacitor comprising a single-layer capacitor, wherein the single-layer capacitor functions as both as a capacitor for the optical receiver subassembly and a standoff for properly positioning the photodetector above the top surface of the header base;
a wire bond electrically connecting the DC bias input lead to the standoff-capacitor; and
a cap mounted to the surface of the header base and enclosing the preamplifier, standoff-capacitor, and photodetector, and said cap including a transparent top enabling light waves to pass though the cap and impact the photodetector.

19. A capacitor assembly, comprising:
a header having a surface;
a standoff mounted to the surface for properly positioning a device above the surface of the header base;
a device mounted on a top of the standoff; and
said standoff comprising a capacitor that is electrically connected between the device and the surface of the header.
